(19) United States
(12) Patent Application Publication
(10) Pub. No.: US 2013/0108435 A1
(43) Pub. Date: May 2, 2013

(54) MOUNTING DEVICE FOR FAN

(71) Applicant: HAI-QING ZHOU, SHENZHEN CITY (CN)

(72) Inventor: HAI-QING ZHOU, SHENZHEN CITY (CN)

(73) Assignees: HON HAI PRECISION INDUSTRY CO., LTD., TU-CHENG (TW); HONG FU JIN PRECISION INDUSTRY (SHENZHEN) CO., LTD., SHENZHEN CITY (CN)

(21) Appl. No.: 13/288,901

(22) Filed: Nov. 3, 2011

(30) Foreign Application Priority Data
Oct. 31, 2011 (CN) 201110337192.1

(51) Int. Cl. F01D 25/28; F16M 13/00

(52) U.S. Cl. 415/213.1; 248/674

(57) ABSTRACT

A mounting device includes a base board, two parallel fixing plates extending up from the base board, and a frame for receiving a fan. The fixing plates each define a first vent. Two clamping pieces extend from each fixing plate at opposite sides of the vent toward the other fixing plate. The frame is sandwiched between the clamping pieces and the fixing plates. The frame includes two sidewalls and two end walls. A blocking piece extends up from each sidewall to block the top of the fan.

### BACKGROUND

1. Technical Field

The present disclosure relates to a device for mounting a plurality of fans.

2. Description of Related Art

Many electronic devices use fans to cool electronic components. A fan is ordinarily mounted in the electronic device by a plurality of screws, which makes it difficult and time-consuming to replace or remove the fan for repair.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a mounting device and fans, wherein the mounting device includes a plurality of frames.

FIG. 2 is an exploded, enlarged view of one of frames and one of the fans of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

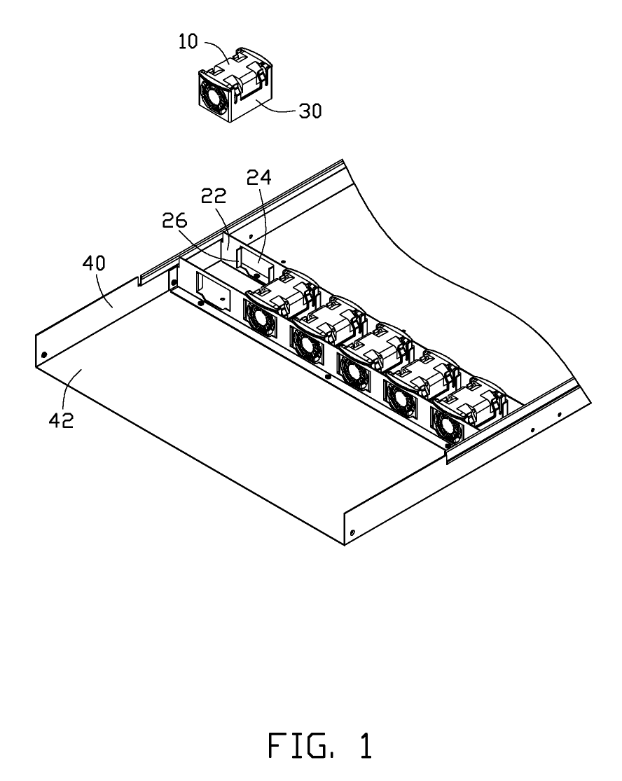

Referring to FIG. 1, an exemplary embodiment of a mounting device for mounting a plurality of fans 10 includes a chassis 40 and a plurality of frames 30.

The chassis 40 includes a base board 42. Two parallel fixing plates 22 which are a mirror image of each other perpendicularly extend up from the base board 42. The fixing plates 22 each defines a plurality of vents 24. The vents 24 in each of the fixing plates 22 align with each other. Two clamping pieces 26 extend inwards from each fixing plate 22.

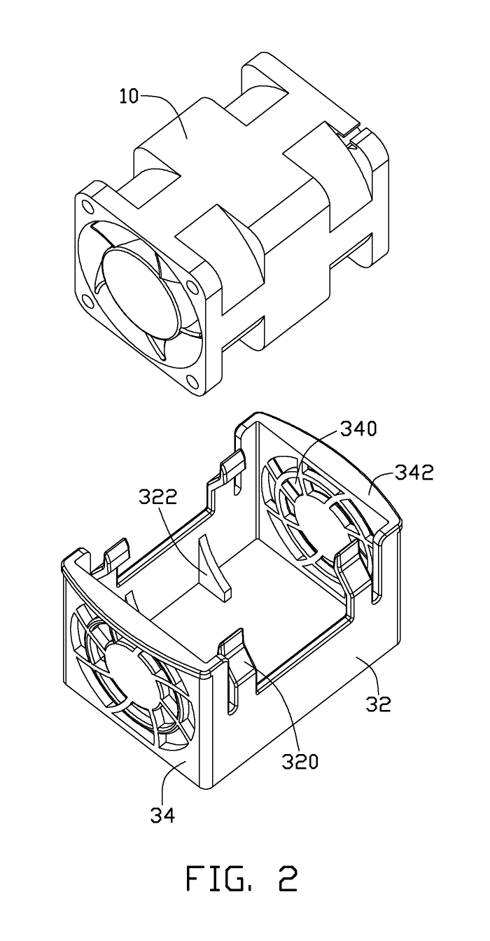

Referring to FIG. 2, each frame 30 is substantially cuboid in outline and includes two sidewalls 32 and two end walls 34. Two resilient blocking pieces 320, adjacent to the end walls 34, extend up from the top of each sidewall 32. Each blocking piece 320 slants inwards and then upwards, the inner surface of the topmost part of each blocking piece 320 being chamfered. Two supporting portions 322 protrude from the inner surface of each sidewall 32. Each end wall 34 defines a vent 340 in the center. A lip or step (operation portion 342) extends outwards from the top of each end wall 34.

In assembly, each fan 10 is received in one of the frames 30 and deforms the blocking pieces 320 outwards, until the bottom of the fan 10 rests on the supporting portions 322. The blocking pieces 320 move back to their original position to hold the fan 10 captive. The frame 30 together with the fan 10 is then received between the fixing plates 22 and slotted between opposing clamping pieces 26. The operation portions 342 abut the top edges of the fixing plates 22. The vents 340 are in alignment with the vents 24.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A mounting device for fixing a fan, comprising:
a base board;
two parallel fixing plates extending up from the base board, each fixing plate defining a first vent, two clamping pieces extending from each fixing plate at opposite sides of the first vent; and
a frame for receiving the fan sandwiched among the fixing plates and the clamping pieces, the frame comprising two sidewalls and two end walls each connected between corresponding ends of the sidewalls, a blocking piece extending up from each sidewall to block a top of the fan.

2. The mounting device of claim 1, wherein each end wall defines a second vent aligning with the first vent of each fixing plate, an operation portion extends outward from each end wall.

3. The mounting device of claim 1, wherein a supporting portion protrudes from an inner surface of each side wall to support the fan.

4. The mounting device of claim 1, wherein each blocking piece slants inwards and then upwards, the inner surface of the topmost part of each blocking piece being chamfered.

5. An assembly, comprising:
a base board;
two parallel fixing plates extending up from the base board, each fixing plate defining a first vent, two clamping pieces extending from each fixing plate at opposite sides of the first vent;
a fan; and
a frame sandwiched among the fixing plates and the clamping pieces, the frame comprising two sidewalls and two end walls each connected between corresponding ends of the sidewalls, the fan accommodated among the sidewalls and the end walls, and aligning with the first vents of the fixing plates, a blocking piece extending up from each sidewall to block a top of the fan.

6. The assembly of claim 5, wherein each end wall defines a second vent aligning with the first vent of each fixing plate.

7. The assembly of claim 5, wherein an operation portion extends outward from each end wall.

8. The assembly of claim 5, wherein a supporting portion protrudes from each side wall to support the fan.

9. The assembly of claim 5, wherein each blocking piece slants inwards and then upwards, the inner surface of the topmost part of each blocking piece being chamfered.
